(19) United States
(12) Patent Application Publication
(10) Pub. No.: US 2009/0157876 A1
(43) Pub. Date: Jun. 18, 2009

(54) Methods, Systems, And Computer Readable Media For Managing User Access To An Electronic Media Sharing Environment

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/957,753

(22) Filed: Dec. 17, 2007

(51) Int. Cl. G06F 15/16

(52) U.S. Cl. 709/225

(57) ABSTRACT

Managing user access to an electronic media sharing environment is described. An account balance representing a data volume authorized for download via the electronic client is maintained for a user of an electronic client,. The account balance is increased/decreased by a predetermined amount as the electronic client uploads/downloads electronic data to/from a common datastore sharing accessibility of the electronic data among a plurality of users. The predetermined amount is based on at least one of a data quantity and a data quality of the electronic data being uploaded or downloaded. When the account balance is less than a predetermined amount associated with a requested download, an alternate version of the electronic data having at least one of lesser data quantity and a lesser data quality than the electronic data requested to be downloaded in the user request is provided for the electronic client to download.

### BACKGROUND

Media devices of all kinds are ubiquitous. One of the most popular media devices is the digital camera. Also increasing in popularity is the smart-phone, a device that combines the functions and features of cell phone with the functions and features of a camera. Other types of media devices include video cameras, computers with media viewing or playing software, media players, and combinations of any of the aforementioned media devices.

As consumers with media devices produce and/or store more and more media in the forms of photographs, videos and sounds, these consumers typically want to share their media with a larger group, like their families or circles of friends.

Users who share media may also wish for other members of the larger group to share media with them. Photo and media sharing websites today support sharing of media in groups. Websites like FACEBOOK and MYSPACE allow users to share media among friends and peers joined in like groups. While these sites place physical limits on the amount of the media to be shared, they place no limits on who within the group can obtain the media and do not provide incentives to group members for media sharing.

Peer-to-peer media sharing systems, such as NAPSTER, rate users on the amount of media content that they provide to other users. However, prior or current implementations of NAPSTER do not couple the amount of media content that a user makes available to other users to content that is made available to the sharing user. The decision on whether to allow a user to download content from another user is binary—either the user is allowed to download the content or not. For example, in initial implementations of NAPSTER, a user was allowed to download files from other users provided that the user made at least some media files available for download by other users. The current implementation of NAPSTER is subscription-based where users are allowed unlimited access to media files based on payment of a subscription fee. However, like the prior implementations, the decision as to whether to allow access to shared media is binary—either the user is allowed to download files or not. There is no incentive for a user to make available for media sharing a volume of media that is commensurate with the volume of shared media that the user downloads. There is likewise no incentive for a user to make a quality of media available for sharing that is of the same or higher quality than the media that the user downloads from a media sharing environment. Accordingly, in light of these difficulties, there exists a need for methods, systems, and computer readable media for managing user access to an electronic media sharing environment.

### SUMMARY

The subject matter described herein relates to methods, systems, and computer readable media for managing user access to an electronic media sharing environment. According to one aspect, a method for managing user access to an electronic media sharing environment is provided. The method includes maintaining, for a user of an electronic client, an account balance representing a data volume authorized for download via the electronic client. The account balance is increased or decreased by a predetermined amount responsive to determining that the electronic client has uploaded or downloaded, respectively, electronic data to or from a common datastore sharing accessibility of the electronic data among a plurality of users. The predetermined amount is based on at least one of a data quantity and a data quality of the electronic data being uploaded or downloaded. The method further includes determining, responsive to a user request to download electronic data via the electronic client, whether the account balance is less than a predetermined amount associated with the download. Responsive to a determination that the account balance is less than a predetermined amount of data volume associated with a download, the method includes providing for the electronic client to download an alternate version of the electronic data having at least one of lesser data quantity and a lesser data quality than the electronic data requested to be downloaded in the user request.

According to another aspect of the subject matter described herein, a system for managing user access to an electronic media sharing environment is provided. The system includes a user reward manager configured for maintaining, for a user of an electronic client, an account balance representing a data volume authorized for download via the electronic client. The user reward manager increases or decreases the account balance by a predetermined amount responsive to a determination that the electronic client has uploaded or downloaded, respectively, electronic data to or from a common datastore sharing accessibility of the electronic data among a plurality of users. The predetermined amount is based on at least one of a data quantity and a data quality of the electronic data being uploaded or downloaded. The system further includes a media file manager that determines, responsive to a user request to download electronic data via the electronic client, whether the account balance is less than a predetermined amount associated with the download, and, responsive to a determination that the account balance is less than a predetermined amount of data volume associated with the download, for providing for the electronic client to download an alternate version of the electronic data having at least one a lesser data quantity and a lesser data quality than the electronic data requested to be downloaded in the user request.

According to another aspect of the subject matter described herein, a system for managing user access to an electronic media sharing environment is provided. The system includes means for maintaining, for a user of an electronic client, an account balance representing a data volume authorized for download via the electronic client. The system includes means for increasing or decreasing the account balance by a predetermined amount responsive to determining that the electronic client has uploaded or downloaded, respectively, electronic data to or from a common datastore sharing accessibility of the electronic data among a plurality of users. The predetermined amount is based on at least one of a data quantity and a data quality of the electronic data being uploaded or downloaded. The system includes means for, responsive to a determination that the account balance is less than a predetermined amount of data volume associated with a download, providing for the electronic client to download an alternate version of the electronic data having at least one of a lesser data quantity and a lesser data quality than the electronic data requested to be downloaded in the user request.

According to another aspect of the subject matter described herein, a computer readable medium embodying a computer program executable by a machine, for managing user access to an electronic media sharing environment is provided. The computer program includes executable instructions for maintaining, for a user of an electronic client, an account balance representing a data volume authorized for download via the electronic client. The computer program further includes executable instructions for increasing or decreasing the account balance by a predetermined amount responsive to determining the electronic client has uploaded or downloaded, respectively, electronic data to or from a common datastore sharing accessibility of the electronic data among a plurality of users. The amount is based on at least one of a data quantity and a data quality of the electronic data being uploaded or downloaded. The computer program further includes instructions for determining, responsive to a user request to download electronic data via the electronic client, whether the account balance is less than a predetermined amount associated with the download. The computer program further includes instructions for, responsive to a determination that the account balance is less than a predetermined amount of data volume associated with the download, providing for the electronic client to download an alternate version of the electronic data having at least one of a lesser data quantity and a lesser data quality than the electronic data requested to be downloaded in the user request.

### BRIEF DESCRIPTION OF THE DRAWINGS

Preferred embodiments of the subject matter described herein will now be explained with reference to the accompanying drawings of which:

FIG. 1 is a flow chart illustrating an exemplary process for managing user access to an electronic media sharing environment according to an embodiment of the subject matter described herein;

FIG. 2A is a block diagram illustrating a client-server based environment in which a system for managing user access to an electronic media sharing environment according to an embodiment of the subject matter described herein can be implemented;

FIG. 2B is a block diagram illustrating a peer-to-peer environment in which a system for managing user access to an electronic media sharing environment according to an embodiment of the subject matter described herein can be implemented;

FIG. 3A is a block diagram illustrating exemplary components of a system for managing user access to an electronic media sharing environment according to an embodiment of the subject matter described herein;

FIG. 3B is a block diagram illustrating in more detail exemplary components of a system for managing user access to an electronic media sharing environment according to an embodiment of the subject matter described herein;

FIG. 4 is a diagram illustrating an exemplary user login screen that may be presented by a system for managing user access to an electronic media sharing environment according to an embodiment of the subject matter described herein;

FIG. 5 is a diagram illustrating an exemplary graphic that may be presented by a system for managing user access to an electronic media sharing environment according to an embodiment of the subject matter described herein, where the graphic illustrates user quota tracking;

FIGS. 6A and 6B are diagrams illustrating graphics for receiving settings for rewards and tariffs provided by a system for managing user access to an electronic media sharing environment according to an embodiment of the subject matter described herein for uploading or downloading data;

FIG. 7 is a diagram illustrating an exemplary graphic that may be presented by a system for managing user access to an electronic media sharing environment according to an embodiment of the subject matter described herein, where the graphic illustrates genealogical information that may be verified by a user;

FIG. 8 is a diagram illustrating an exemplary graphic that may be presented by a system for managing user access to an electronic media sharing environment according to an embodiment of the subject matter described herein, where the graphic illustrates verification of genealogical information;

FIG. 9 is a diagram illustrating an exemplary graphic that may be presented by a system for managing user access to an electronic media sharing environment according to an embodiment of the subject matter described herein, where the graphic illustrates media files available for download;

FIG. 10 is a diagram illustrating an exemplary graphic that may be presented by a system for managing user access to an electronic media sharing environment according to an embodiment of the subject matter described herein, where the graphic illustrates actions that may be performed when a user account balance is insufficient for a download;

FIG. 11 is a diagram illustrating an exemplary graphic that may be presented by a system for managing user access to an electronic media sharing environment according to an embodiment of the subject matter described herein, where the graphic illustrates media degradation methods for different media types; and

FIG. 12 is a diagram illustrating an exemplary virtual world environment that may be presented by a system for managing user access to an electronic media sharing environment according to an embodiment of the subject matter described herein.

### DETAILED DESCRIPTION

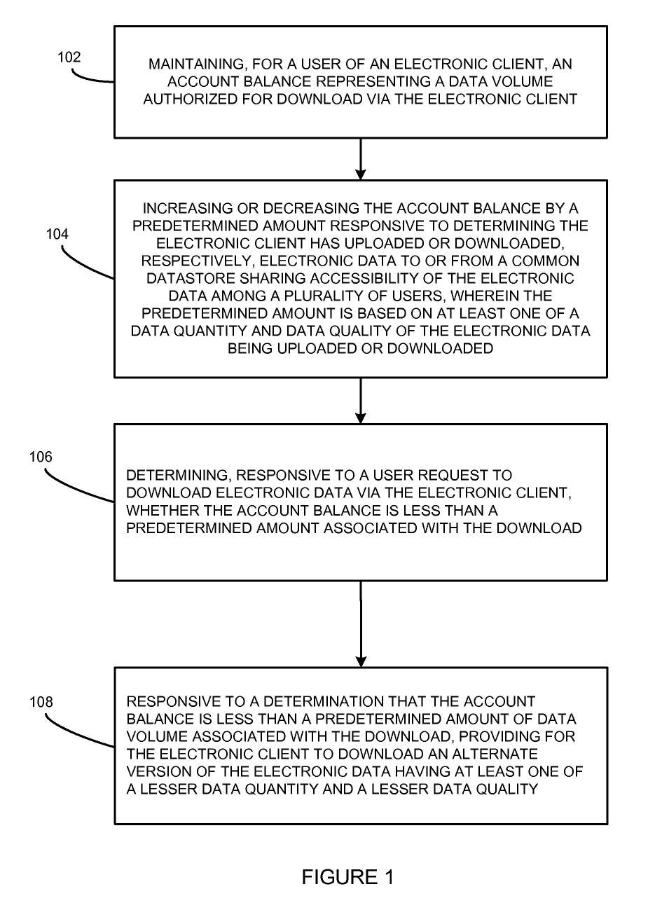

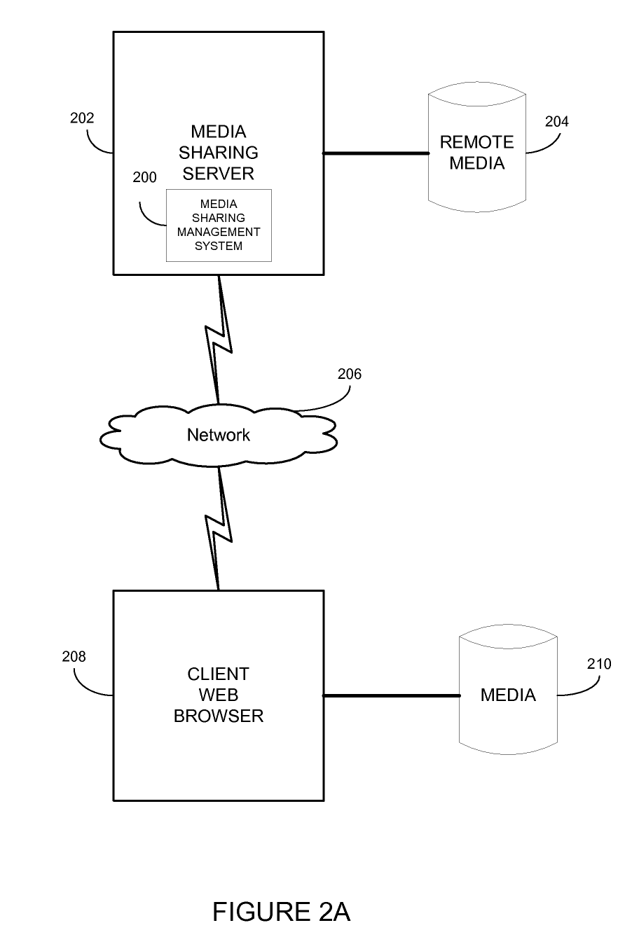

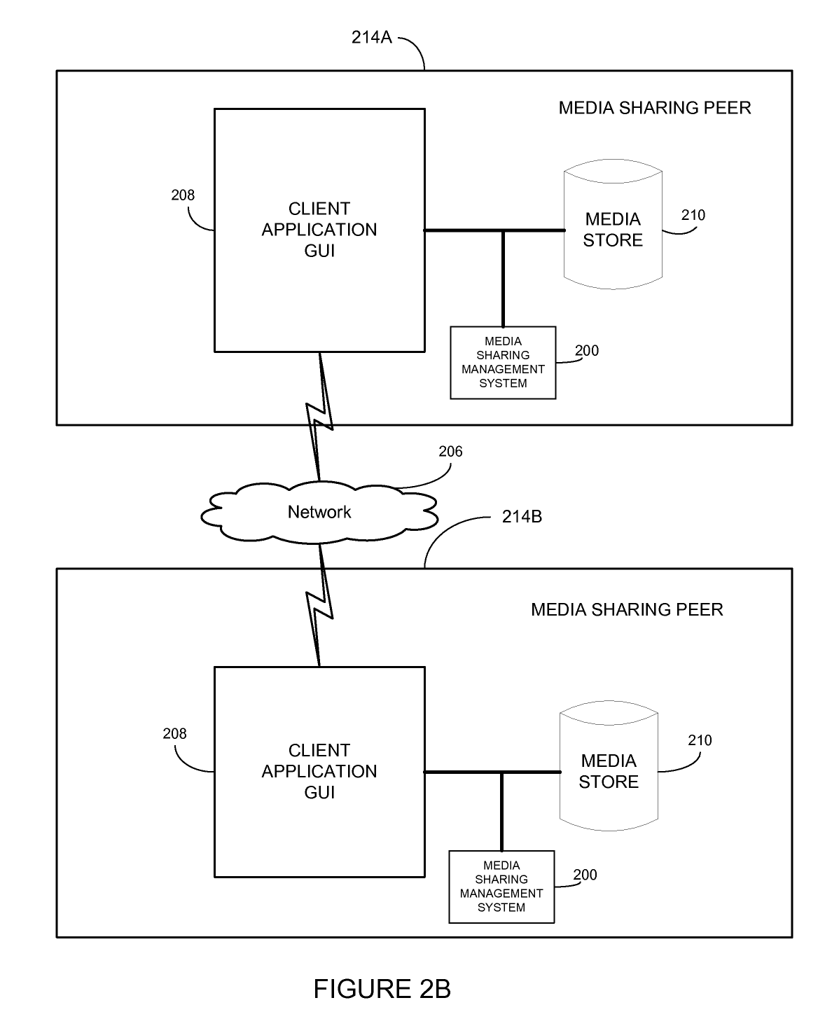

The subject matter described herein includes methods, systems, and computer readable media for managing user access to an electronic media sharing environment. According to one aspect of the subject matter described herein, a method for providing user access to an electronic media sharing environment is provided. FIG. 1 is a flow chart of an exemplary process for managing user access to an electronic media sharing environment according to an embodiment of the subject matter described herein. Referring to FIG. 1, in block 102, the method includes, maintaining for a user of an electronic client, an account balance representing a data volume authorized for download via the electronic client. For example, each user that desires to share media files, such as audio files, video files, image files, files containing genealogical data, files containing wiki data or any combination thereof, may have an account balance indicating the amount and/or quality of media data that the user is authorized to download from an electronic media sharing environment. As used herein, the term “wiki data” refers to factual information that may be posted in an encyclopedia-like media sharing environment for sharing with other users. The amount and/or quality of media indicated by the user's account balance may be represented in any suitable manner. In one exemplary implementation described in detail below, the amount is represented in reward units. A system for managing user access to an electronic media sharing environment includes means for maintaining, for a user of an electronic client, an account balance representing the data volume that the user is authorized to download via the electronic client. In general, the system may be implemented in any suitable environment. In FIG. 2A, a media sharing management system 200 is implemented on a media sharing server 202. Media sharing management system 200 may maintain account balances for users for downloading data from remote media datastore 204. In this example, a client may download media files via a network 206 and a client web browser 208. Web browser 208 may be implemented on any suitable client device, including a personal computer, a mobile phone, a personal digital assistant, smart phone, digital media player, digital camera, video camera or any combination thereof. Media downloaded by a client may be stored in local media store 210.

In another exemplary environment illustrated in FIG. 2B, media sharing management system 200 may be implemented in a peer-to-peer system. In the illustrated example, media sharing management system 200 is implemented on media sharing peers 214A and 214B for controlling access to their local media stores 210. Peers 214A and 214B may each include a web browser 208 or other suitable software for downloading media files from the other peer's media sharing management system via network 206. When a media sharing peer 214A or 214B downloads data from the other media sharing peer, the downloading media sharing peer's account balance maintained by the media sharing management system 200 on the peer from which the data is downloaded will be debited by an appropriate amount. Similarly, when, a media sharing peer 214A or 214B uploads data to a remote media sharing peer (e.g., in response to a download request from the remote media sharing peer or spontaneously, in response to an indication from the remote media sharing peer that a certain type of data is desired for upload), the uploading peer's account balance may be credited by an amount by which media sharing management system 200 on the remote peer values the upload. A peer-to-peer media sharing environment, such as that illustrated in FIG. 2 may be implemented between any number of media sharing peers, where each peer includes a media sharing management system with the functionality described herein.

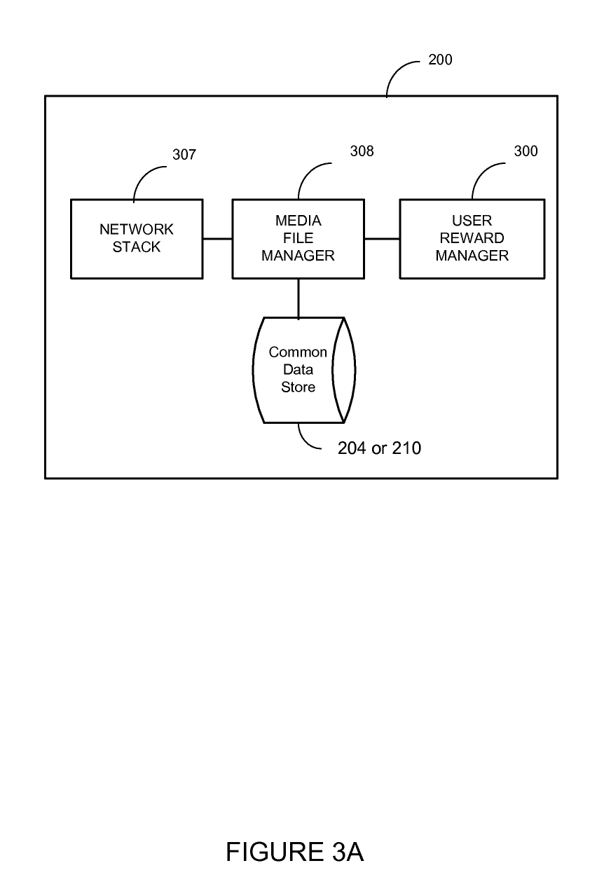

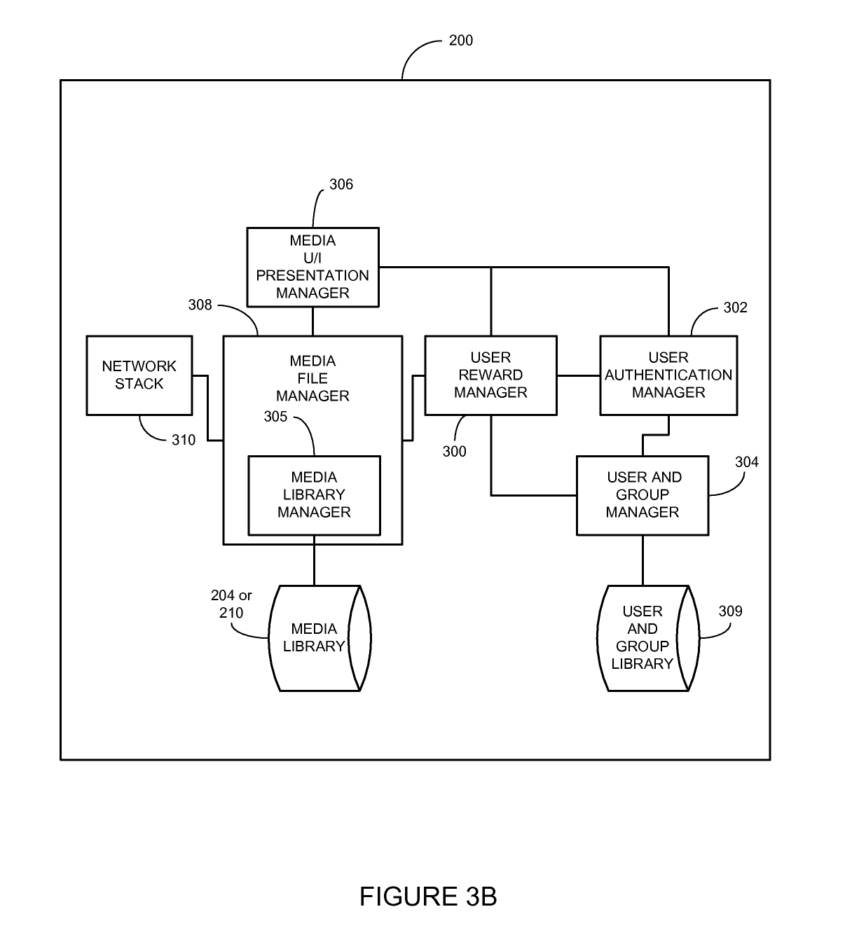

FIGS. 3A and 3B illustrate exemplary components of system 200 for maintaining a user account balance and managing access to media files in an electronic media sharing environment. For example, referring to FIGS. 3A and 3B, a user reward manager 300 is a component of media sharing management system 200 that can be included on a server or a peer. User reward manager 300 can be a client-server application, a peer-to-peer application or any other form of application. User reward manager 300 maintains a reward unit balance, referred to herein as an “RU” balance for the user.

A user may begin interaction with media sharing management system 200 by connecting to media sharing management system 200 and, through a login user interface (not shown), authenticating to media sharing management system 200. For example, as illustrated in FIG. 3B, user reward manager 300 can communicate with a user authentication manager 302, which manages the login and authentication process for the user. When the user enters his or her login credentials, typically a user ID and password, user authentication manager 302 calls a user and group manager 304 to determine if the user's login credentials are correct. If the user has entered correct credentials, the user is logged into media sharing management system 200 and a session is established for the user.

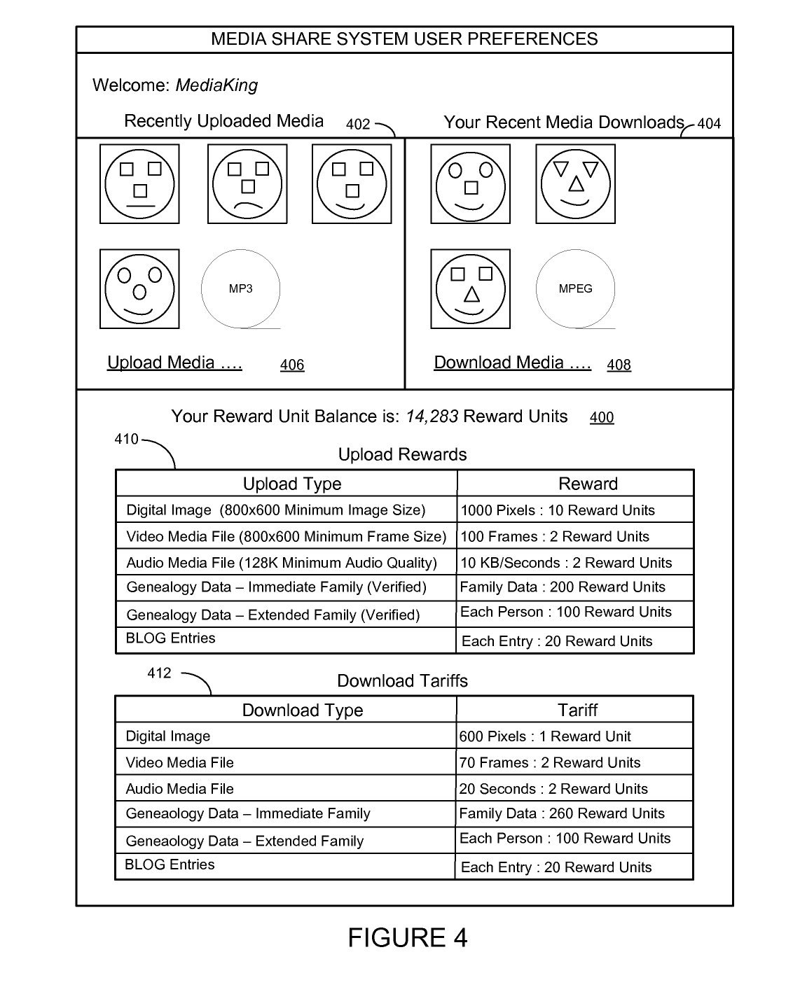

Upon successful login, a media U/I presentation manager 306 presents to the user a media share system welcome screen. FIG. 4 is a representative illustration of the welcome screen user interface that may be presented by media U/I presentation manager 306. Referring to FIG. 4, component 400 shows the user's account balance in reward units. Components 402 and 404 respectively illustrate recently uploaded and downloaded media. Each of components 402 and 404 include links 406 and 408 for uploading and downloading media files, respectively. Tables 410 and 412 respectively illustrate upload rewards and download tariffs for different media types.

Reward units are used within media sharing management system 200 to track each user's upload contributions and download liabilities. The goal of maintaining a reward unit balance for a user is to entice each user to contribute media files of interest to the other users of media sharing management system 200. The more media a user uploads to media sharing management system 200, the more media the user will be able to download. If a user does not have the reward units to download a selection of media, media sharing management system 200 will notify the user of the insufficient balance. The user may then upload more media, or continue to download the list of media. When media is downloaded and there are insufficient reward units to cover the cost of the media, lower quality versions of media files will be downloaded for the user.

Returning to FIG. 1, in block 104, a method for managing user access to an electronic media sharing environment includes increasing or decreasing the account balance by a predetermined amount responsive to determining the electronic client has uploaded or downloaded, respectively, electronic data to or from a common datastore sharing accessibility of the electronic data among a plurality of users. The predetermined amount is based on at least one of a data quantity and a data quality of the electronic data being uploaded or downloaded. For example, a user's account balance maintained by media sharing management system 200 may be increased by a predetermined amount in response to the user uploading data. The amount of increase may be adjusted based on the quantity or quality of data being uploaded. For example, if the shared media files are image files, the user may be credited with more reward units for uploading image files of a high resolution. Similarly, the user may not receive any upload credit for uploading files that the user has already uploaded or that have been previously uploaded to the electronic media sharing environment by other users. Exemplary methods for verifying or evaluating the quality of data uploads will be described in more detail below.

The amount of reward units deducted from the user's account balance for downloading may also be based on a quantity or quality of a download. For example, a user's account may be debited more for downloading high resolution images than for downloading low resolution images.

A system for managing user access to an electronic media sharing environment includes means for increasing or decreasing the account balance by a predetermined amount responsive to determining that the electronic client has uploaded or downloaded, respectively, electronic data to or from a common datastore sharing accessibility of the electronic data among a plurality of users, wherein the predetermined amount is based on at least one of a data quantity and a data quality of the electronic data being uploaded or downloaded. User reward manager 300 illustrated in FIGS. 3A and 3B may control the amount of increasing or decreasing of the user's account balance in response to data uploads or downloads. For example, user reward manager 300 may analyze electronic data being uploaded by the electronic client and adjust the amount of increasing based on results of the analyzing. In one example, the amount of increasing of the user's account balance may be adjusted to zero, if the data is determined to be duplicative of data previously uploaded. In another example, the amount of increasing of the user's account balance may be enhanced if the uploaded data is of at least a predetermined quality.

Uploaded data to be shared with other users may be stored in remote media store 204 in a client-server environment or in local media store 210 in a peer-to-peer environment. In the embodiment illustrated in FIG. 3B, the shared media store is implemented as a media library accessible via a media library manager 305.

The user begins an upload process by clicking the “upload media” link 406 of FIG. 4. The user is presented with a file selection user interface (not shown) that allows the user to navigate his or her available media.

Media that is uploaded or downloaded using system 200 can be of virtually any type of media capable of being represented in electronic format, including digital images, video clips containing video streams and optionally audio streams, audio clips containing audio streams, genealogical data or other data that relates the members of the system, and even BLOG entries and information. This is not an exhaustive list of the types of media that can be uploaded to and managed by media sharing management system 200. Any media type may be added to the electronic media sharing environment, including conceptual media, like tokens that grant access to areas of a common virtual world or other conceptual media. The administrator of media sharing management system 200, through system configuration (not shown) may add any new media type as an acceptable type for uploading.

Once the user has selected one or more media files for upload, the user presses an “upload” button of the user interface to begin the upload process. Using file transfer capabilities of the client, each file is uploaded to media sharing management system 200. The files are received by network stack 307 of FIGS. 3A and 3B and passed to a media file manager 308. Media file manager 308 determines the value of the each file uploaded and calls the user reward manager 300 to add the reward to the user's reward unit balance for each file successfully uploaded. If a file of a particular type requires upload verification, the reward is deferred until the file is verified. Each time the user's reward unit balance is updated, user reward manager 300 calls user and group manager 304 to store the latest reward unit balance in the user's record in user and group library 309.

Media sharing management system 200 monitors each user's upload and download patterns, and, in particular, the average upload/download ratio the user maintains when a particular type of quality reduction is employed.

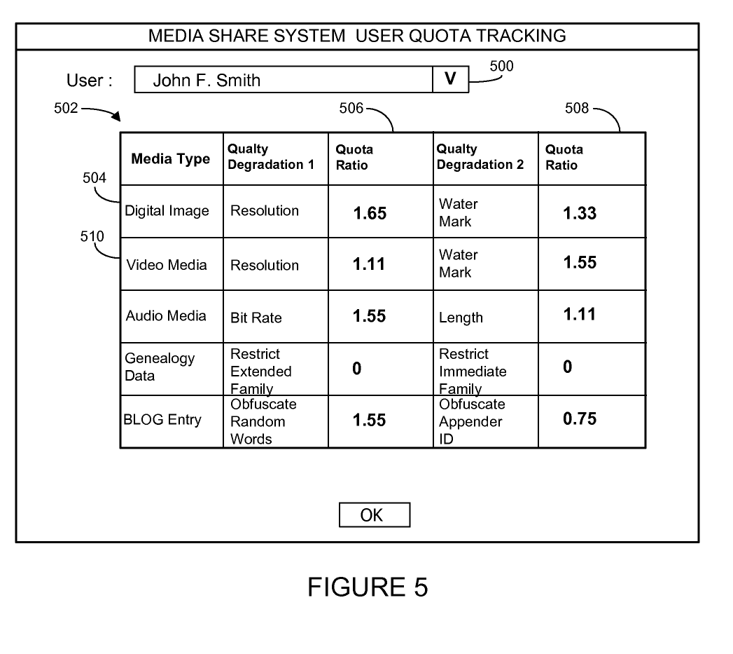

FIG. 5 shows a table for user “John F. Smith” that summarizes the upload/download ratios for this user. These numbers represent a decimal fractional value of the ratio of uploads in reward units to downloads in reward units. A ratio of “1.00” represents an equal value of uploaded and downloaded media measured in reward units. A number greater than “1.00” denotes more or higher value uploads than downloads while a number less than “1.00” denotes more or higher value downloads than uploads. In the example illustrated in FIG. 5, item 500 allows the administrator of media sharing management system 200 to select a user whose quotas are being tracked. Table 502 represents media types, quality degradations, and quota ratios for the user. For example, the cell at row 504, column 506 in table 502 indicates a quota ratio of 1.65 for digital images with quality degradation 1. This value indicates that the user John F. Smith uploads 1.65 times as many reward units value of digital images than he downloads if the quality degradation is set to 1 or “resolution.” Similarly, the cell at row 504, column 508 in table 502 indicates a quota ratio of 1.33 if the quality degradation is changed to quality degradation number 2 or “watermark.” Thus, changing this particular user's quality degradation method can affect the user's decision to upload or download data.

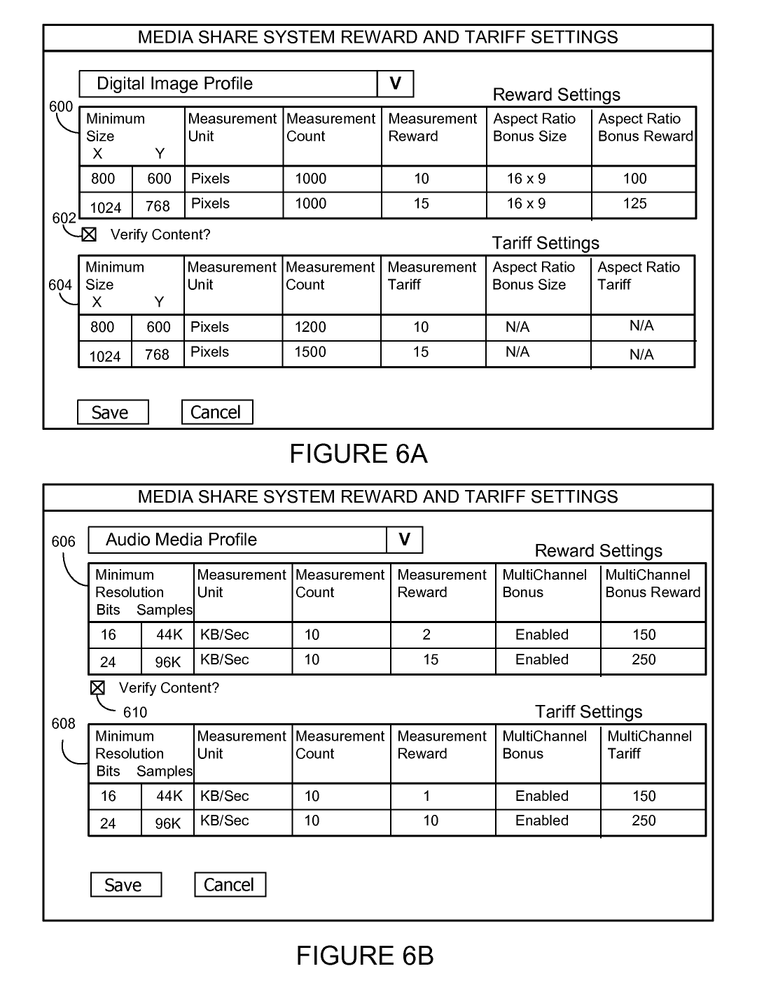

FIG. 6A and 6B respectively illustrate media share system reward and tariff settings for digital images and audio files. In FIG. 6A, table 600 represents reward settings for uploading digital image files of different resolutions. Check box 602 indicates whether or not the content of digital image files is to be verified. Verifying the content of digital image files may include analyzing previously uploaded files by this user or by other users and adjusting the reward based on whether the images are previously uploaded and/or whether the user owns the copyright in the digital image. Table 1 shown below illustrates examples of verifications that may be applied by system 200 for different media types.

TABLE 1
Exemplary Media Verification Tests

| | Types of Tests than can be |
|---|---|
| Media Type | applied: |
| Photographs/Images | Duplicate test. Does the |
| | image already exist in the |
| | system? |
| | Resolution test: Does EXIF |
| | data and current image |
| | resolution verify the original |
| | resolution of the image? |
| | Copyright test. Does |
| | submitter own the |
| | copyright? |
| | DRM test. Does image |
| | contain DRM? |
| Video | Duplicate test. Does the |
| | video already exist in the |
| | system? Is it a subset clip |
| | of another video |
| | Is the video a lower |
| | resolution duplicate of a |
| | higher resolution video |
| | Copyright test. Does |
| | submitter own the |
| | copyright? |
| | DRM test. Does the video |
| | contain DRM? |
| Audio | Duplicate test. Does the |
| | audio already exist in the |
| | system? Is it a subset clip |
| | of another audio clip? |
| | Is the audio a lower |
| | resolution duplicate of a |
| | higher resolution audio clip |
| | including a version with less |
| | channels or reversed |
| | channels from the original |
| | Copyright test. Does |
| | submitter own the |
| | copyright? |
| | DRM test. Does the video |
| | contain DRM? |
| Genealogical Data | Is the genealogical data |
| | already in the system? |
| | Is the data accurate, |
| | verifying the data with |
| | known other sources of |
| | information, including public |
| | internet sites, other family |
| | member's data, etc. |
| Wiki Data | Have “N” other users in the |
| | group verified the data in |
| | the wiki post. |

Using the tests in Table 1 above, the reward given for uploading of files may be adjusted. Similarly, the tariff charged for downloading media may also be adjusted. For example, if an added wiki entry has been verified by a predetermined number of users, its value and corresponding reward units cost may be increased.

Returning to FIG. 6A, table 604 represents tariff settings for downloading digital images. As with the reward unit setting in table 600, the amount of reward units charged for each download varies with image resolution. Each of the values in tables 600 and 604 may be defined by a system administrator.

In FIG. 6B, table 606 represents reward settings for uploading audio files, and table 608 indicates tariff settings for downloading audio files. In tables 606 and 608, the number of reward units awarded or deducted for uploading or downloading audio media varies with the sampling rate used to generate the audio media. As with table 600, check box 610 allows a user to select whether or not system 200 is to verify uploaded audio content.

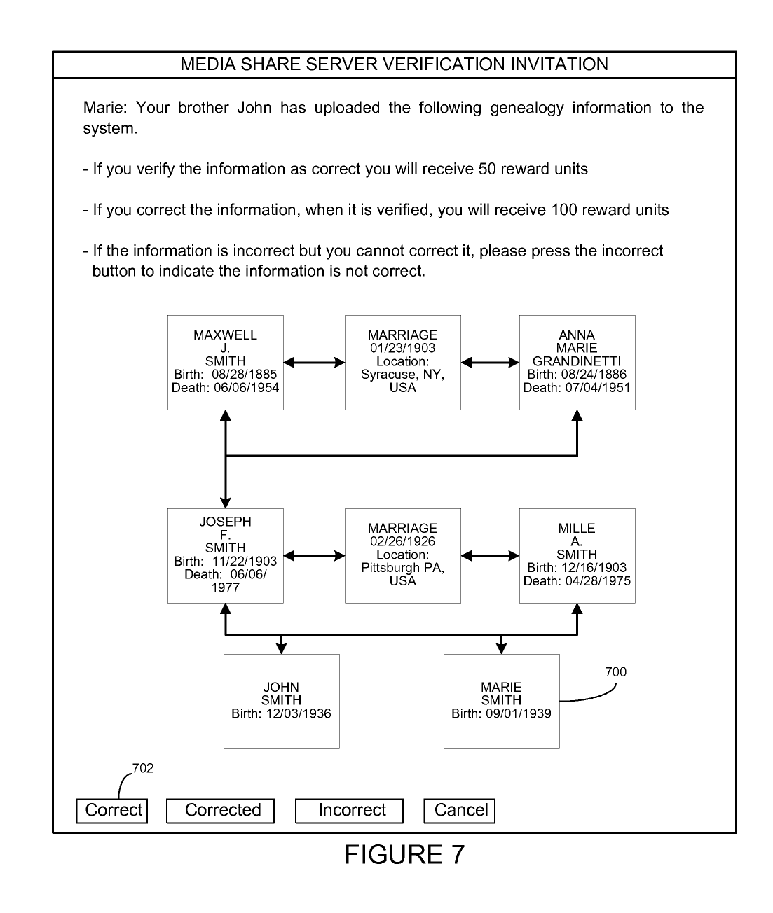

If verification is turned on for a media type, then the media must be verified before the user is credited with reward for the media upload. FIG. 7 shows genealogical data that was uploaded to media sharing management system 200 by user “John Smith”. John Smith is a member of the immediate family being represented by the uploaded genealogical data.

The verification flag for genealogical data was turned on in the system configuration. This sets a state in media sharing management system 200 for user John Smith to seek verification of the data by someone other than John Smith. At some time later, Marie Smith, a sibling of John Smith, as shown in component 700, is authenticated by media sharing system and logged in. Media sharing management system 200 recognizes Marie Smith as a sibling of John Smith, and in the configuration of media sharing management system 200, it is specified that any member of the immediate family may verify the data.

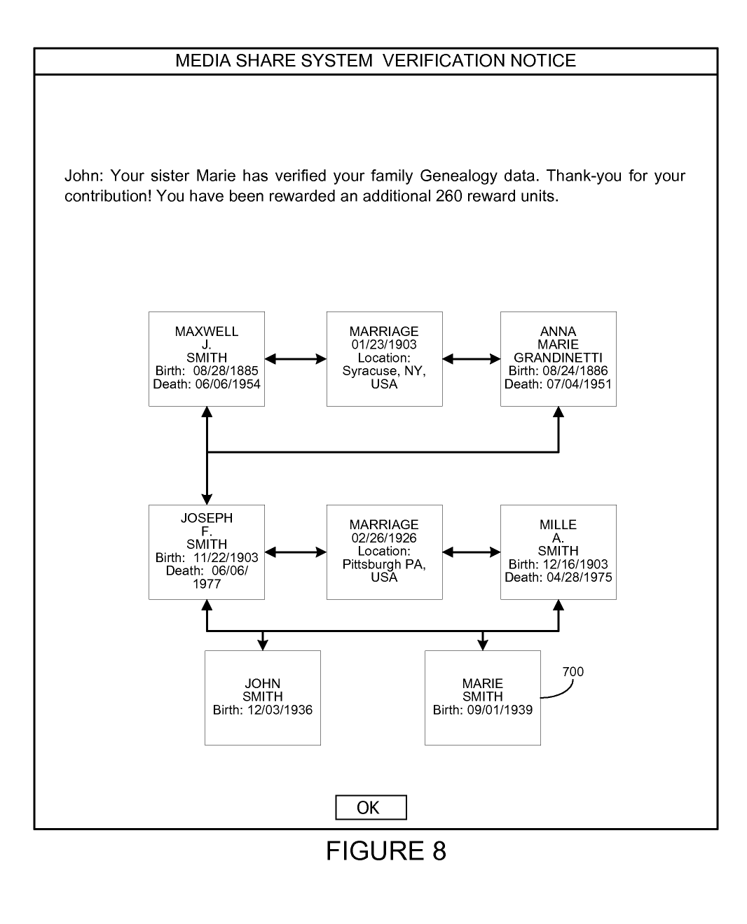

Marie Smith is presented with the user interface shown in FIG. 7 and asked to verify the family genealogical data presented. If Marie finds the data is all correct, then Marie indicates this by pressing the “Correct” button 702 to signal the data is correct. Media sharing management system 200 receives this response via media UI presentation manager 306 of FIG. 3B and signals user reward manager 300 that the value of the data is to be credited to the user's account. In the example illustrated in FIG. 7, it is assumed that Marie verified the information as correct by pressing Correct button 702 and thus receives 50 reward units. Once Marie verifies the genealogical information uploaded by John, the next time John logs in, he may be presented with the verification screen illustrated in FIG. 8, which indicates to John that he has been rewarded 260 reward units because the genealogical information that he uploaded was verified by another user.

Returning to FIG. 1, in block 106, a method for managing user access to an electronic media sharing environment includes determining, responsive to a user request to download electronic data via the electronic client, whether the account balance is less than a predetermined amount associated with the download. For example, the user's account balance may be compared with the cost in reward units associated with the download. A system for managing user access to an electronic media sharing environment includes means for determining, responsive to a user request to download electronic data via the electronic client, whether the account balance is less than a predetermined amount associated with the download. For example, media file manager 308 illustrated in FIGS. 3A and 3B may determine whether the cost associated with the download is greater than the user's account balance or vice versa. In order to initiate a download, a user may invoke download link 408 of media share system welcome screen illustrated in FIG. 4 to begin downloading one or more media files available via media sharing management system 200. The user is presented with a user interface for selecting available media for download.

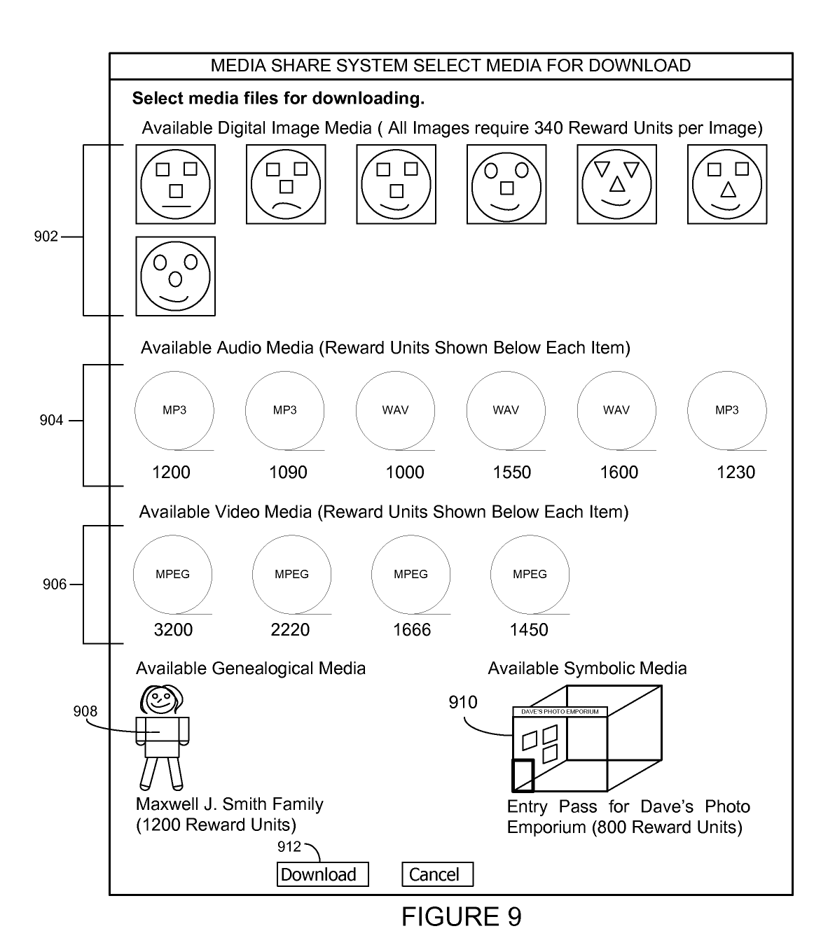

FIG. 9 illustrates an exemplary user interface for selecting media for download. The user may select any combination of media for download. More particularly, in FIG. 9, icons 902 represent digital images available for download and their corresponding reward unit costs, icons 904 represent audio files available for download and their corresponding reward units cost, icons 906 represent video files available for download and their corresponding reward units cost icon 908 represents genealogical data available for download and its corresponding reward units cost and icon 910 represents a key to a virtual world environment and its corresponding reward units cost. Once the user selects one or more media items shown by the user interface illustrated in FIG. 9, the user invokes the “download” button 912 to begin downloading the selected media.

Media UI presentation manager 306 of FIG. 3B passes to media file manager 308 the list of media files the user has selected for download. Media file manager 308 calculates the required reward unit cost for each media item by calling user reward manager 300 with the media file type and size. User reward manager 300 returns the cost of the media item and the account balance of the user to media file manager 308. Media file manager 308 calculates the total cost for the list of files to determine if the user has sufficient reward units balance.

If the user has sufficient reward units balance to cover the cost in reward units for the list of media the user has selected, media file manager 308 begins transferring the selected files, at their highest available qualities, to the user's client by passing the contents of each file to network stack 307, for transfer to the client. Network stack 307 may employ a file transfer protocol (FTP), hypertext transfer protocol (HTTP), or other suitable protocol, including a proprietary file transfer protocol, to transfer files to the client.

Returning to FIG. 1, in block 108, a method for managing user access to an electronic media sharing environment includes, responsive to a determination that the account balance is less than a predetermined amount of data volume associated with the download, providing the electronic client to download an alternate version of the electronic data having at least one of a lesser data quantity and a lesser data quality. For example, if the electronic data sought to be downloaded is image and the user's account balance is insufficient for the download, an image of reduced resolution than the image requested to be downloaded may be provided for downloading. In another example, if the user's account balance is insufficient, an image with an electronic water mark visible in the image may be provided for download.

A system for managing user access to an electronic media sharing environment includes means for, responsive to a determination that the account balance is less than a predetermined amount of data volume associated with the download, providing for the electronic client to download an alternate version of the electronic data having at least one of a lesser data quantity and a lesser data quality. For example, media file manager 308 illustrated in FIG. 3 may provide for the electronic client to download an alternate version of the electronic data if the user's account balance is insufficient.

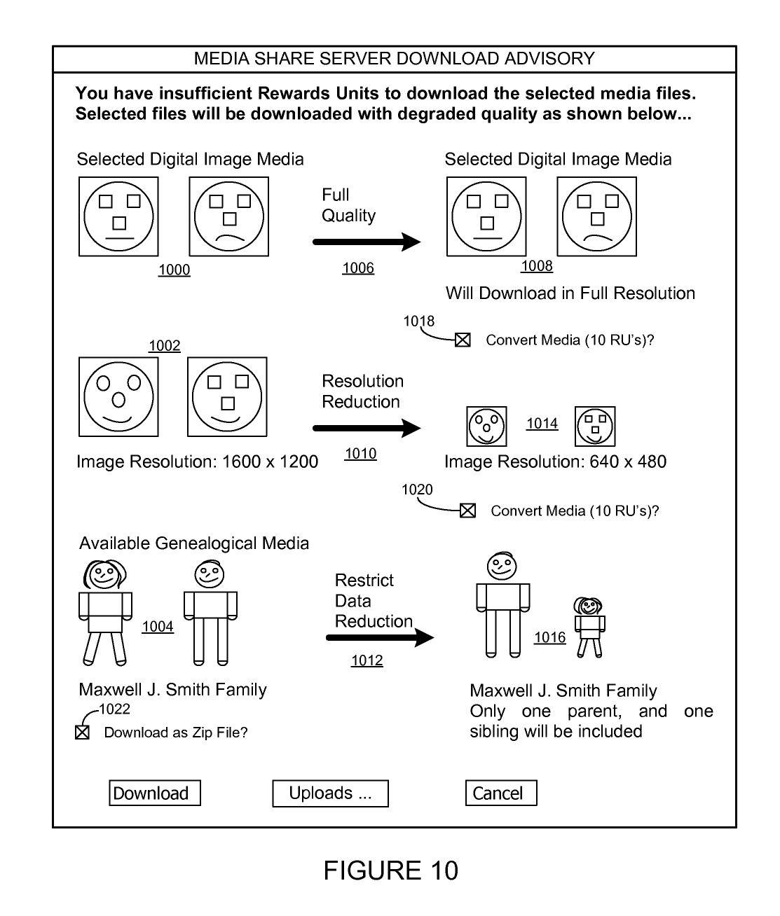

If media file manager 308 determines that the user's account does not have sufficient reward units to cover the download cost of the list of media, the user may be notified that media items in the download list will be degraded. FIG. 10 is an exemplary user interface that shows a list of media items the user has requested for download, the files which will be downloaded in full quality, and the files that will be degraded, including the type of degradation applied. More particularly, in FIG. 10, items 1000, 1002, and 1004 indicate media files that the user has selected for download. Component 1006 indicates that the digital image media files 1000 will download at full quality as represented by icons 1008. However, because the user has insufficient balance to download all of the images at full quality, components 1010 and 1012 indicate that media items 1002 and 1004 will be degraded. For example, icons 1014 indicate that image files of reduced resolution will be downloaded, and icons 1016 indicate that a reduced set of genealogical data will be downloaded.

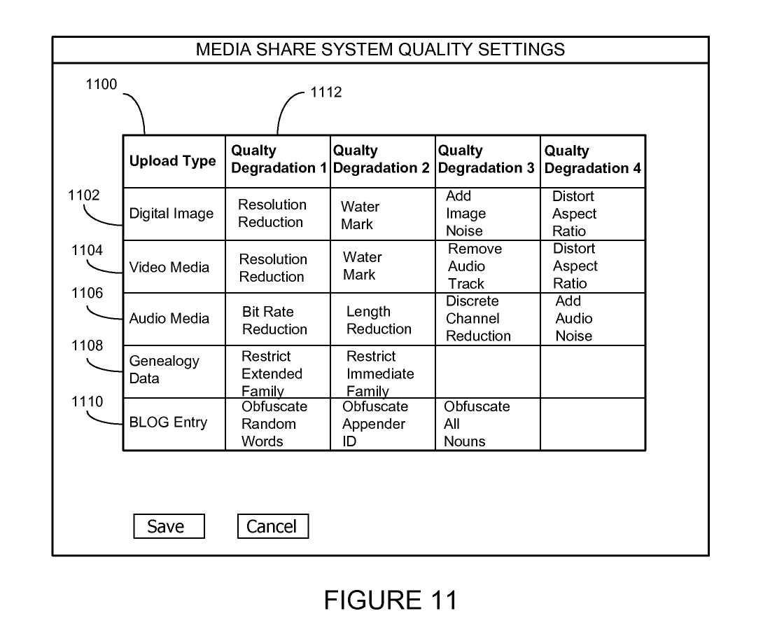

Media sharing management system 200 may select the quality degradation technique from a plurality of quality degradation techniques based on media type and/or the user in order to encourage the user to upload media to the common datastore. FIG. 11 illustrates a table 1100 of configured media quality degradations based on media type. In table 1100, column 1101 shows the media types. Each row in the table shows the available reductions that have been configured for that media type. For example, row 1102 shows the quality degradation techniques for digital images, row 1104 shows the quality degradation techniques for video media, row 1106 shows quality degradation techniques for audio media, row 1108 shows quality degradation techniques for genealogy data, and row 1110 shows quality degradation techniques for BLOG entries. This table shows a representative set of media types that can be supported; however, this list is not intended to be an exhaustive list of media types or degradation techniques supported. For example, Table 2 shown below illustrates additional examples of degradation methods that may be applied to different media types.

TABLE 2
Degradation Methods for Different Media Types

| Media Type | Presentable Degradations |
|---|---|
| Photographs/Images | Decreased Resolution |
| | Decreased Size |
| | Thumbnail |
| | Add watermark or other |
| | distortion |
| | Change aspect ratio |
| | Cropping |
| Video | Decreased Resolution |
| | Decreased Size |
| | Allowable stream-able |
| | viewing, but no download. |
| | Change aspect ratio |
| | Allow download of 4:3 |
| | clipped version of clip of an |
| | HD 16:9 resolution |
| | Cropping |
| Audio | Decreased bit-rate |
| | Reduce Channel |
| | Resolution. |
| | Change Channel Locations |
| Genealogical Data | Include Names, limit other |
| | kinds of information |
| | (important dates, |
| | addresses, etc) |
| | Provide only part of a |
| | genealogical sub-tree |
| Wiki Data | Allow viewing of only partial |
| | entries of a given subject |

As stated above, ratios of uploads to downloads may be maintained and used to select quality degradation methods for a specific user in order to encourage the user to upload more media than the user is downloading. These ratios are tracked based on the media type and the quality degradation type as shown in FIG. 5. In this way the administrator of system 200 can assign a new quality degradation type to a user for a given media type if the current reduction type does not yield a quota ratio of “1.00” or greater.

In one exemplary implementation, the first quality degradation applied when a user's account balance is insufficient for a download is selected from the first column as shown in column 1112 of FIG. 11. If that quality degradation results in a quota ratio of 1.0 or greater, system 200 may maintain that quality degradation for future downloads. System 200 may monitor the quota ratio for the user over time. If the selected quality degradation method yields a decreasing quota ratio or a quota ratio that is less 1, system 200 may automatically change the quality degradation method, for example, to the next successive degradation method illustrated in table 1100. System 200 continually monitors the quota ratio for a user and adjusts the quality degradation method for each media type to optimize the quota ratio. The system administrator, through system configuration using the table in FIG. 11, may modify the order of selection of quality degradations for each media type.

When the user selects a plurality of media for download, but does not have sufficient reward units for all of the media, media file manager 308 calls user reward manager 300 to determine the optimal quality reduction technique for the media. User reward manager 300 calls user and group manager 304 to retrieve the table of quality degradations and associated upload/download ratios from the user's record in user and group library 309.

For each media file to be degraded, user reward manager 300 selects the degradation technique based on the highest upload/download ratio as shown in FIG. 5 and communicates the selection to media file manager 308. Media file manager 308 selects the media file to be downloaded based on the original media file selection and the selected degradation technique. Using the table in FIG. 5 as an example, for digital image media for John Smith the quality degradation to be employed for digital images will be “resolution reduction”. If John F. Smith selected to download video media (see row 510 of the table), the quality degradation applied would be “water mark” based on the higher download ratio of “1.55” for downloads when the “water mark” degradation is employed versus the ratio of “1.11” when “resolution reduction” is employed.

Once media sharing management system 200 has determined the list of full quality and degraded quality media files to be downloaded, media file manager 308 begins calling network stack 307 to download the files to the client device.

As the client receives the media files from media sharing management system 200, media file manager 308 notifies user reward manager 300 of each file transfer. User reward manager 300 calculates a new upload/download ratio based on the media type and the reward (uploaded file) or tariff (downloaded file) associated with the media file. User reward manager 300 then calls user and group manager 304 to store the in the user's record in user and group library 309 the updated upload/download ratio for the media file type and quality degradation technique.

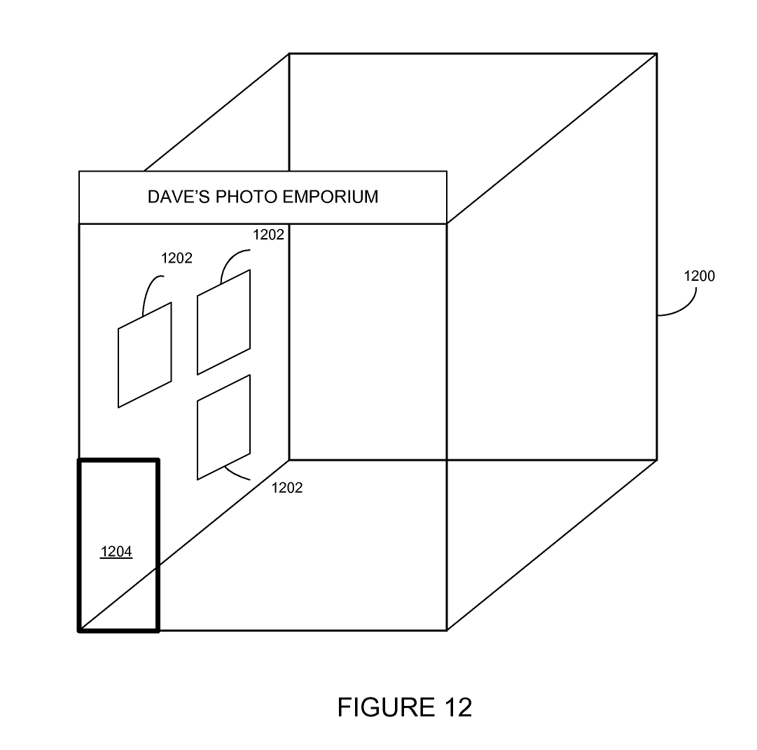

In one enhancement of the subject matter described herein, media objects may be presented to a user for download via a virtual world environment. For example, media sharing management system 200 may indicate to a user that electronic data is available for sharing via a datastore and the electronic data may be available or accessible through a virtual world environment. In one implementation, the user may be provided with a key having a value based on the user's account balance. The key provides access to at least one of uploading and downloading data via the virtual world environment. The determination as to whether the user has a sufficient account balance to enter the virtual world environment may be made based on the key's reward unit value. In FIG. 9, element 910 represents a key or entry pass for downloading data via a virtual world environment. FIG. 12 illustrates an example of such an environment. In FIG. 12, environment 1200 may be a three-dimensional virtual world presented by media sharing management system 200 to a user. In environment 1200, media files available for download may be presented as virtual objects 1202. Each virtual object 1202 may be an icon or picture on a virtual wall that represents a media file designed to be downloaded. The media files represented and available for download may be image files, video files, audio files, or any combination thereof. The user may use key 910 to access door 1204 into the virtual environment 1200.

According to another enhancement of the subject matter described herein, media sharing management system 200 may support campaigns where media of a specific type or event is being collected. During the campaign, additional incentives or reward points may be given for added media during the campaign. In one example, a user may be seeking images of members of a family tree. Anyone who uploads an image of a family member that has not already been uploaded may be given an enhanced number of reward units for the uploading.

According to another aspect of the subject matter described herein, media sharing management system 200 may convert the format of media requested to be downloaded into a format selected by a user. For example, in FIG. 10, components 1018 and 1020 allow a user to select media format conversion for a predetermined number of reward units. When the media is downloaded, the user will be prompted for the format to which the media should be converted. Before the download, the media will be converted by media sharing management system 200 to the desired format.

According to another enhancement of the subject matter described herein, downloaded media may be packaged into a zip file or other archived format to facilitate the downloading and storage of media. Referring to FIG. 10, check box 1022 allows the user to select “download as a zip file.” When this box is checked, media sharing management system 200 will pack all files to be downloaded into a single zip file, naming the zip file with the time and date as follows, “2007-11-15-12-50-PM-media.zip”. In this manner, one file can be downloaded that includes all of the media files that were selected, and the files can both compressed and, if desired, encrypted, in the zip file.

According to another enhancement of the subject matter described herein, a user may volunteer to be a site verifier of all media. For example, a user may volunteer to be the verifier of data uploaded to datastore 204 or 210. The user may receive reward units for performing the verification. In addition, the user may control the amount of reward units given for each upload. Alternatively, verification may be automatically performed by user reward manager 300 as described above.

According to yet another enhancement of the subject matter described herein, media sharing management system 200 may provide multimedia summaries of available media for download. Such multimedia summaries may include any metadata associated with the media, including the file name and a description of the media content.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11 (a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

1. A method for managing user access to an electronic media sharing environment, the method comprising:
maintaining, for a user of an electronic client, an account balance representing a data volume authorized for download via the electronic client;
increasing or decreasing the account balance by a predetermined amount responsive to determining the electronic client has uploaded or downloaded, respectively, electronic data to or from a common datastore sharing accessibility of the electronic data among a plurality of users, wherein the predetermined amount is based on at least one of a data quantity and data quality of the electronic data being uploaded or downloaded;
determining, responsive to a user request to download electronic data via the electronic client, whether the account balance is less than a predetermined amount associated with the download; and
responsive to a determination that the account balance is less than a predetermined amount of data volume associated with the download, providing for the electronic client to download an alternate version of the electronic data having at least one of a lesser data quantity and a lesser data quality than the electronic data requested to be downloaded in the user request.

2. The method of claim 1 wherein the maintaining, increasing or decreasing, determining, and providing for are performed at a server.

3. The method of claim 1 wherein the maintaining, increasing or decreasing, determining, and providing for are performed at a peer of the electronic client

4. The method of claim 1 comprising analyzing electronic data uploaded by the electronic client and adjusting an amount of the increasing of the account balance based on results of the analyzing.

5. The method of claim 4 wherein adjusting an amount of the increasing of the account balance based on results of the analyzing includes setting the amount of the increasing to zero in response to determining that the electronic data uploaded by the electronic client is duplicative of data present in the common datastore.

6. The method of claim 4 wherein adjusting an amount of the increasing of the account balance based on results of the analyzing includes enhancing an amount of the increasing based on a quality of the electronic data uploaded by the electronic client.

7. The method of claim 1 wherein the electronic data comprises image data.

8. The method of claim 7 wherein providing for the electronic client to download an alternate version of the electronic data having at least one of a lesser data quality and a lesser data quantity includes providing for the electronic client to download an image of at least one of a lower resolution and a reduced size than the image data requested to be downloaded in the user request.

9. The method of claim 7 wherein providing for the electronic client to download an alternate version of the electronic data having at least one of a lesser data quantity and a lesser data quality includes providing for the electronic client to download image data having an electronic water mark visible in the image data.

10. The method of claim 1 wherein the electronic data comprises at least one of audio data, video data, wiki data, and genealogical data.

11. The method of claim 1 wherein providing for the electronic client to download an alternate version of the electronic data having at least one of a lesser data quantity and a lesser data quality includes selecting a degradation method from a plurality of degradation methods for encouraging the user to upload electronic data to the common datastore.

12. The method of claim 1 comprising:
indicating to a user that electronic data is available for sharing via the datastore, wherein the electronic data is available via a virtual world environment: and
providing the user with a key having a value based on the account balance, the key providing access for at least one of uploading and downloading the electronic data via the virtual world environment;
wherein determining whether the account balance is less than a predetermined amount associated with the download includes determining whether the value of the key exceeds a download cost associated with the download.

13. A system for managing user access to an electronic media sharing environment, the system comprising:
a user reward manager configured for maintaining, for a user of an electronic client, an account balance representing a data volume authorized for download via the electronic client, for increasing or decreasing the account balance by a predetermined amount responsive to a determination that the electronic client has uploaded or downloaded, respectively, electronic data to or from a common datastore sharing accessibility of the electronic data among a plurality of users, wherein the predetermined amount is based on at least one of a data quantity and data quality of the electronic data being uploaded or downloaded; and
a media file manager for determining, responsive to a user request to download electronic data via the electronic client, whether the account balance is less than a predetermined amount associated with the download, and responsive to determining that the account balance is less than a predetermined amount of data volume associated with the download, providing for the electronic client to download an alternate version of the electronic data having at least one of a lesser data quantity and a lesser data quality than the electronic data requested to be downloaded in the user request.

14. The system of claim 13 wherein the user reward manager and the media file manager are implemented on a server.

15. The system of claim 13 wherein the user reward manager and the media file manager are implemented on an entity having a peer relationship with respect to the electronic client.

16. The system of claim 13 wherein the user reward manager is configured for analyzing electronic data uploaded by the electronic client and for adjusting an amount of the increasing of the account balance based on results of the analyzing.

17. The system of claim 16 wherein the user reward manager is configured for setting the amount of the increasing of the account balance to zero in response to determining that the electronic data uploaded by the electronic client is duplicative of data present in the common datastore.

18. The system of claim 16 wherein the user reward manager is configured for enhancing the amount of the increasing of the account balance based on a quality of the electronic data.

19. The system of claim 13 wherein the electronic data comprises image data and wherein the media file manager is configured for providing for the electronic client to download an image of at least one of a lower resolution and a reduced size than the image data requested to be downloaded in the user request.

20. The system of claim 13 wherein the electronic data comprises image data and wherein the media file manager is configured for providing for the electronic client to download image data having an electronic water mark visible in the image data.

21. The system of claim 13 wherein the electronic data comprises at least one of image data, audio data, video data, wiki data, and genealogical data.

22. The system of claim 13 wherein the user reward manager is configured for selecting a degradation method from a plurality of degradation methods for encouraging the user to upload electronic data to the common datastore.

23. The system of claim 13 wherein the media file manager is configured for:
indicating to a user that electronic data is available for sharing via the datastore, wherein the electronic data is available via a virtual world environment: and
providing the user with a key having a value based on the account balance, the key providing access for at least one of uploading and downloading the electronic data via the virtual world environment;
wherein determining whether the account balance is less than a predetermined amount associated with the download includes determining whether the value of the key exceeds a download cost associated with the download.

24. A system for managing user access to an electronic media sharing environment, the system comprising:
means for maintaining, for a user of an electronic client, an account balance representing a data volume authorized for download via the electronic client;
means for increasing or decreasing the account balance by a predetermined amount responsive to determining the electronic client has uploaded or downloaded, respectively, electronic data to or from a common datastore sharing accessibility of the electronic data among a plurality of users, wherein the predetermined amount is based on at least one of a data quantity and data quality of the electronic data being uploaded or downloaded;
means for determining, responsive to a user request to download electronic data via the electronic client, whether the account balance is less than a predetermined amount associated with the download; and
means for responsive to a determination that the account balance is less than a predetermined amount of data volume associated with the download, providing for the electronic client to download an alternate version of the electronic data having at least one of a lesser data quantity and a lesser data quality than the electronic data requested to be downloaded in the user request.

25. A computer-readable medium embodying a computer program executable by a machine, for managing user access to an electronic media sharing environment, the computer program comprising executable instructions for:
maintaining, for a user of an electronic client, an account balance representing a data volume authorized for download via the electronic client;
increasing or decreasing the account balance by a predetermined amount responsive to determining the electronic client has uploaded or downloaded, respectively, electronic data to or from a common datastore sharing accessibility of the electronic data among a plurality of users, wherein the predetermined amount is based on at least one of a data quantity and data quality of the electronic data being uploaded or downloaded;
determining, responsive to a user request to download electronic data via the electronic client, whether the account balance is less than a predetermined amount associated with the download; and
responsive to a determination that the account balance is less than a predetermined amount of data volume associated with the download, providing for the electronic client to download an alternate version of the electronic data having at least one of a lesser data quantity and a lesser data quality than the electronic data requested to be downloaded in the user request.
